(19) United States
(12) Patent Application Publication
(10) Pub. No.: US 2026/0210686 A1
(43) Pub. Date: Jul. 23, 2026

(54) BUMP BOARD

(71) Applicant: AOB Products Company, Columbia, MO (US)

(72) Inventors: Mark Dalton, Columbia, MO (US); Dennis Cauley, Fayette, MO (US); Russell Bergeron, Columbia, MO (US); Timothy S. Kinney, Warrenton, MO (US); Max Willoughby, Columbia, MO (US); Kyle Martin, Columbia, MO (US); Michael Boeding, Columbia, MO (US)

(73) Assignee: AOB Products Company, Columbia, MO (US)

(21) Appl. No.: 19/453,500

(22) Filed: Jan. 20, 2026

Related U.S. Application Data
(60) Provisional application No. 63/747,550, filed on Jan. 21, 2025.
(60) Provisional application No. 63/755,290, filed on Feb. 7, 2025.
(60) Provisional application No. 63/789,584, filed on Apr. 16, 2025.

(51) Int. Cl. G01B 3/20; A01K 97/00

(52) U.S. Cl. CPC G01B 3/205; A01K 97/00

(57) ABSTRACT

An electronic length measuring board, associated components and methods. The electronic fish measuring device for measuring the length of a fish has a fish support including an upper support surface for receiving the fish thereon. The fish support includes a reference for contacting the fish when the fish is on the upper support surface. A length sensor generates length measurement data indicative of a length that the fish extends from the reference when the fish is on the upper support surface and is in contact with the reference. A measurement display is supported by the fish support. A controller is operatively connected to the length sensor and the measurement display. The controller controls the measurement display to display a length measurement value corresponding to the length of the fish for visual observation by a user. The length measurement value is based on the length measurement data.

### CROSS-REFERENCE TO RELATED APPLICATIONS

The present application claims the benefit of priority to U.S. Provisional Ser. No. 63/747,550, filed Jan. 21, 2025, U.S. Provisional Ser. No. 63/755,290, filed Feb. 7, 2025, and U.S. Provisional Ser. No. 63/789,584, filed Apr. 16, 2025, the entireties of which are hereby incorporated by reference herein.

### FIELD

The present disclosure generally relates to measuring devices used to measure the length of something, such as a fish.

### BACKGROUND

Fishermen can use measuring devices, such as bump boards, to measure the length of a caught fish.

### SUMMARY

In one aspect, an electronic fish measuring device for measuring the length of a fish comprises a fish support including an upper support surface configured to receive the fish thereon. The fish support includes a reference configured to contact the fish when the fish is on the upper support surface. A length sensor is configured to generate length measurement data indicative of a length that the fish extends from the reference when the fish is on the upper support surface and is in contact with the reference. A measurement display is supported by the fish support. A controller is operatively connected to the length sensor and the measurement display. The controller is configured to control the measurement display to display a length measurement value corresponding to the length of the fish for visual observation by a user. The length measurement value is based on the length measurement data.

In another aspect, an electronic fish measuring device for measuring the length of a fish comprises a fish support including an upper support surface configured to receive the fish thereon. The fish support includes a reference configured to contact the fish when the fish is on the upper support surface. A length sensor is configured to generate length measurement data indicative of a length that the fish extends from the reference when the fish is one the upper support surface and is in contact with the reference. A wireless port is configured to communicate with an external electronic device. A controller is operatively connected to the length sensor and the wireless port. The controller is configured to cause the wireless port to send a measurement message to the external electronic device as a function of the length measurement data.

Other objects and features of the present disclosure will be in part apparent and in part pointed out herein.

### BRIEF DESCRIPTION OF THE DRAWINGS

FIG. 1 is a perspective of an electronic measuring device according to one embodiment of the present disclosure;

FIG. 2 illustrates a fish disposed on the electronic measuring device;

FIG. 3 is a block diagram of the electronic measuring device;

FIG. 4 is an enlarged, fragmentary perspective of a user interface of the electronic measuring board;

FIG. 5 is a plan view of the electronic measuring device with no fish present;

FIG. 6 is an exploded view of a deck of the electronic measuring device;

FIG. 7 is an enlarged, fragmentary plan view of a slider of the electronic measuring device;

FIG. 8 is an enlarged, fragmentary perspective of the slider;

FIG. 9 is a bottom perspective view of the slider;

FIG. 10 is a bottom perspective view of the electronic measuring device;

FIG. 11 is a fragmentary perspective end view of the electronic measuring device; and

FIG. 12 is an enlarged, fragmentary perspective view of a pusher ear of the slider.

Corresponding reference numbers indicate corresponding parts throughout the drawings.

### DETAILED DESCRIPTION

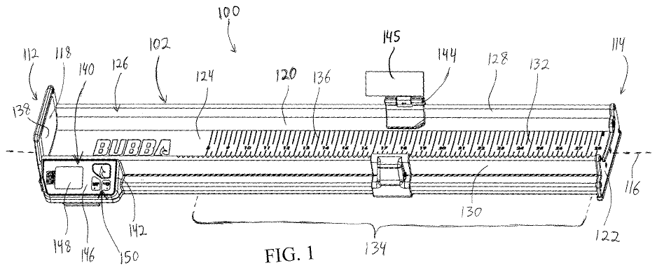

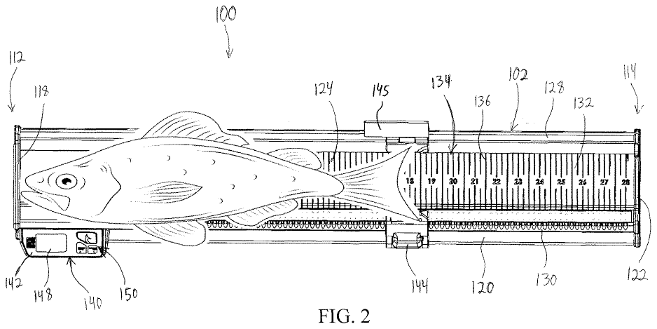

Referring to FIG. 1, an electronic measuring device according to one embodiment of the present disclosure is generally indicated by reference numeral 100. The electronic measuring device 100 can be referred to as an electronic measuring board (referred to herein as bump board or simply board). The device 100 measures the length of an object that is placed to rest on the device. Embodiments herein describe the object as a fish (FIG. 2 illustrates a fish 10 disposed on the device 100). While described in the context of measuring fish lengths, it is understood that features and aspects of the present disclosure can be applied to measuring the length of other types of objects, such as other animal species, leaves and other plant matter, and the like.

The board 100 is an electronic instrument or device that electronically determines the length of the fish and outputs a length value (length measurement value) for the fish. The board 100 has at least one length sensor that measures the length of the fish disposed on the board 100. For example, the length sensor generates a sensor signal (e.g., length measurement data) indicative of a length that the object extends from a bump wall of the board 100, and the controller receives and interprets the sensor signal to determine a length value for the fish. The controller outputs the length value to convey the fish length to an observer, such as the user that placed the fish on the board 100. For example, the board 100 includes a measurement display (e.g., an integrated digital display), and the controller controls the measurement display to present the length value on a screen of the measurement display for visual observation. Alternatively, or in addition, the board 100 uses an integrated wireless port to communicate a measurement message, indicative of the length measurement value for the fish, to an external device. The external device may be a personal computing device, such as a smartphone, tablet computer, wearable computer, laptop computer, or the like. In another example, the external device may be a network device, such as a router, server, or the like.

The electronic measuring board 100 can be more accurate, more user-friendly, and more informative than known bump boards. For example, the board 100 determines the length value electronically without relying on a visual analysis by the user. And, the board 100 outputs the measured length of the fish to the user as a numeric value already, so the user does not have to mentally convert the closes ruler indicia to a length value. The board 100 has several features that enhance the accuracy, repeatability, and utility of the length measuring operation, as described herein. Furthermore, the board 100 provides additional relevant information to the user beyond length measurement, such as indicating reference lengths or limits, a culling length (e.g., the shortest length in a set of recorded lengths), displaying a unique identifier for verification/authentication purposes, and/or the like.

For example, the board 100 can be used during fishing competitions to assist with verifying and authenticating fish that are caught during the competition. For example, the board 100 may display a unique identifier and/or wirelessly transmit measurement messages that include the unique identifier. The unique identifier may refer to the specific competition, to verify that the length measurement refers to a fish caught during the current competition. The board 100 can also be used during non-competitive fishing events to measure the length of the fish.

Referring to FIGS. 1 and 2, the board 100 includes an object support 102. In the illustrated embodiment, the object support 102 comprises a tray, although other configurations can be used without departing from the scope of the present disclosure. The tray 102 extends from a first end 112 of the tray to a second end 114 of the tray. The tray 102 may extend linearly between the first and second ends 112, 114, along a tray axis 116. The tray 102 is a structural frame that is sized and shaped to receive and support an object along its length. As described above, the following description refers to a fish as an example object that is measured by the board 100, but the board 100 can be used to measure the length of other objects without modifying the board 100 or otherwise departing from the scope of the present disclosure.

The tray 102 includes a reference 118 configured to be contacted by the object (e.g., fish) when the object is on the object support. In use, the user positions an end of the object (e.g., a nose of the fish) against (in contact with) the reference 118. In the illustrated embodiment, the reference 118 comprises a bump wall, although other configurations can be used without departing from the scope of the present disclosure. The bump wall 118 is at the first end 112 of the tray 102. The bump wall 118 is supported by (e.g., coupled to) a deck 120 that is elongated and extends from the bump wall 118 to the second end 114. In an embodiment, the tray 102 has a distal end wall 122 at the second end 114. The deck 120 of the tray 102 has an upper support surface 124 that receives the fish thereon. The upper support surface 124 extends from the bump wall 118 to the distal end wall 122. In the illustrated embodiment, the upper support surface 124 is concave and defines a trough 126 (broadly, an open channel) for retaining the fish on the tray 102. For example, the deck 120 may include first and second side walls 128, 130 that extend the length of the deck 120. The section of the deck 120 between the side walls 128, 130 is a base 132 (e.g., base section). Each side wall 128, 130 has a greater height than the base 132 of the deck 120 therebetween. In use, as shown in FIG. 2, the fish is placed on the deck 120 of the tray 102 and positioned so the mouth of the fish (broadly, an end of the object) abuts the bump wall 118.

The tray 102 can include a ruler 134 that extends along a length of the deck 120. In the illustrated embodiment, the ruler 134 is located on the base 132, between the two side walls 128, 130. The ruler 134 is graduated with ruler markings (e.g., indicia) 136 at fixed increments. The ruler markings 136 are in units of distance (e.g., mm, cm, inches, feet, etc.) The ruler 134 can be viewed by the user to visually determine (e.g., estimate) the length of the fish. As illustrated in FIG. 2, the end of the fish tail aligns with a ruler marking 136 associated with a length of 18.5 units. If desired, the user can visually compare the position of the end of the tail to the ruler 134 and determine the length of the fish. In embodiments described herein, the user does not need to read and interpret the ruler 134 to measure the length of the fish, unless desired, because the board 100 electronically measures the length and presents the measured length to the user. For this reason, the board 100 can operate without the ruler 134 being visible or even present on the tray 102. The ruler 134 is useful for permitting the user to double-check and confirm a measured length (displayed by the measurement display), when desired.

The bump wall 118 has a contact surface 138 configured to abut the mouth of the fish. The contact surface 138 faces toward the opposite end 114 of the tray 102 and the distal end wall 122. The contact surface 138 may be planar. The plane of the contact surface 138 may be perpendicular to the tray axis 116. The bump wall 118 may be taller than the side walls 128, 130. The additional height reduces the risk of the fish mouth passing above a top of the bump wall 118 when pushed against the bump wall 118 to take a length measurement. The bump wall 118 defines an end of the trough 126. The distal end wall 122 may be shorter than the bump wall 118. The tray 102 is designed so that the distal end wall 122 is beyond the end of the fish and does not contact the fish. The distal end wall 122 may be approximately the height of the side walls 128, 130, forming an end cap of the tray 102.

The board 100 includes a primary user interface 140 mounted to the tray 102. A housing 142 of the primary user interface 140 may be integrated into the structural elements of the tray 102. In the illustrated embodiment, the housing 142 of the primary user interface 140 is seamlessly integrated with the second side wall 130. The primary user interface 140 is located next to the bump wall 118. This location allows the user interface 140 to avoid interfering with movement of a slider 144 of the board 100. In other embodiments, the user interface 140 may be spaced apart from the bump wall 118. The user interface 140 has a control face 146 that generally faces away from the trough 126. The control face 146 may be tilted upward generally towards a user that would be standing over the board 100. The primary user interface 140 includes a display (referred to herein as a measurement display) 148 and one or more input actuators 150. The measurement display 148 is configured to display a length value indicating a measured length of the fish that is disposed on the tray 102. The measurement display 148 may be a digital display, and displays the length value as a number.

The slider 144 is a length indicator, marker, or gauge that is moveably mounted to the tray 102 (broadly, moveable relative to the reference 118). The slider 144 is slidable along a length of the tray 102, such as along the length of the ruler 134. The slider 144 is designed to allow the user to reposition the slider 144 so a portion of the slider 144 aligns with the end of the fish tail. In an embodiment, the board 100 determines a length of the fish based on the position of the slider 144 set by the user.

In the illustrated embodiment, the slider 144 has a mount 145 for removably attaching a sign, such as a tournament badge or identification (ID), to the measuring board 100. The mount 145 can be pivotable (via a pivot connection or hinge) relative to a body of the slider 144 to position the sign relative to the fish disposed on the tray 102. When a user takes a photograph of the fish on the board 100, the sign on the mount 145 is within the field of view of the camera. The mount 145 may include a connector (such as a magnet, clip, hook and loop fastener, snap, etc.) for coupling to the sign. The sign may have a card holder that contains a tournament card in a sleeve. The connector may releasably secure the card holder to the mount 145. In an example, the mount 145 itself may be removable from the slider 144 if not needed or desired.

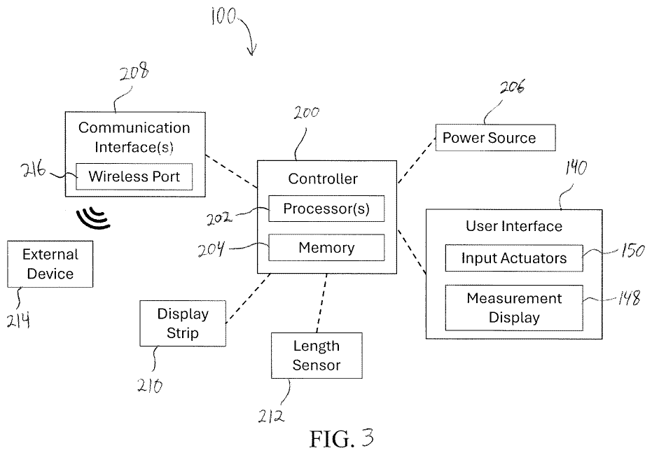

FIG. 3 is a block diagram of the electronic measuring board 100 according to an embodiment. The board 100 includes a controller (or control system) 200 that controls the operation of the board 100. The illustrated components of the board 100 shown in FIG. 1 include the controller 200, a power source 206, the primary user interface 140, one or more communication interface(s) 208, a length display (e.g., display strip) 210, and a length sensor 212.

The controller 200 includes one or more processors 202 and a non-transitory tangible storage medium (referred to herein as memory) 204. The memory 204 stores programmed instructions for operating the board 100. The memory 204 may also store settings, modes, reference length information, and the like. The processor(s) 202 execute instructions (e.g., software programming) stored in the memory 204 embodying the aspects (e.g., functional aspects, operational aspects) of the board 100 described herein to operate the board 100 as described herein. For example, the processor(s) 202 and memory 204 can be provided on a circuit structure (e.g., one or more printed circuit boards (PCBs)). The PCB and/or other circuitry may be disposed within an interior of the tray 102 (e.g., below the upper support surface 124). Other components of the board 100 may be in wired or wireless communication with the controller 200. Other configurations of the controller (broadly, control system) 200 may be used without departing from the scope of the present disclosure.

The power source 206 powers the components of the board 100. The power source 206 may be one or more batteries that provide electrical energy. The electrical energy supplied by the power source 206 powers the controller 200, the primary user interface 140, the communication interface(s) 208, the display strip 210, and the length sensor 212. In an example, the power source 206 includes at least one battery of a first size (e.g., 18650 Lithium-ion Battery) and at least one battery of a second size (e.g., two AAA batteries), smaller than the first size. Optionally, the power source 206 is a battery pack that has one or more battery cells packaged together. In another embodiment, the power source 206 includes an electrical cable/cord configured to plug into a wall outlet.

The communication interface(s) 208 communicates with other devices that are discrete and separate from the board 100. Such devices are referred to as external devices 214. Each external device can be a smartphone, a laptop computer, a tablet computer, a wearable computer, a remote control, a network server, router or other network intermediary device, or the like. In an embodiment, the communication interface(s) 208 include a wireless port (e.g., wireless communication interface) 216 that wirelessly communicates with the external device 214. The wireless port 216 may include a transceiver that receives signals (commands, instructions) from the external device 214 and transmits messages (e.g., measurement messages) to the external device 214. The measurement messages can include the length measurement value, an indication of the length measurement value, the length measurement data, and/or any other suitable information for conveying the length of the object. The wireless port 216 and associated circuitry can communicate using Wi-Fi, radio frequency, Bluetooth, or any other suitable wireless signal/protocol. Other types of wireless communication may be used without departing from the scope of the present disclosure. Optionally, the communication interface(s) 208 also include a wired interface, such as a port (e.g., USB port) that connects to a cable.

As described with reference to FIGS. 1 and 2, the user interface 140 includes a measurement display 148 and input actuators 150 (broadly, user input) that permit the user to interact with the board 100. The input actuators 150 are user input devices designed to be manipulated by the user to provide user input signals that are conveyed to the controller 200. The input actuators 150 may be buttons, switches, knobs, keys, a touchscreen, and the like. For example, the input actuators 150 may include a switch or button for turning the board 100 on and off. Another actuator 150 can be a measure actuator that, when pressed, instructs the controller 200 to generate a length measurement of the fish on the tray 102. Pressing the measure actuator indicates, according to the user, that the fish is appropriately positioned on the tray 102 and the slider 144 is aligned with the tail end of the fish. In an embodiment, another actuator 150 (transmit actuator) instructs the controller 200 to transmit a measurement message, including one or more measured lengths, to the external device 214. For example, a user may select the measure actuator first, and if satisfied with the length value that is calculated by the controller 200, the user may subsequently press the transmit actuator to trigger the controller 200 controlling the wireless port 216 to transmit the length value in a message to the external device 214. The controller 200 may save the length value that is measured on the local memory 204. In response to the user selecting the transmit actuator 150, the controller 200 retrieves the length value and generates a measurement message that contains the length value. Alternatively, a single actuator 150 of the user interface 140 may initiate both the measure and transmit functions of the controller 200 described above, such that the controller 200 automatically transmits the length value upon measuring the length of the fish.

The input actuators 150 may include additional input devices, such as a microphone for receiving and conveying verbal commands to the controller 200. For example, in response to receiving a verbal command of “measure” from the user, the controller 200 may activate the length sensor 212 to generate a length measurement of the fish. By accepting verbal commands, the user can keep one hand on the fish and one hand on the slider 144, if desired, to prevent movement that causes misalignment of the end of the fish tail relative to the slider 144.

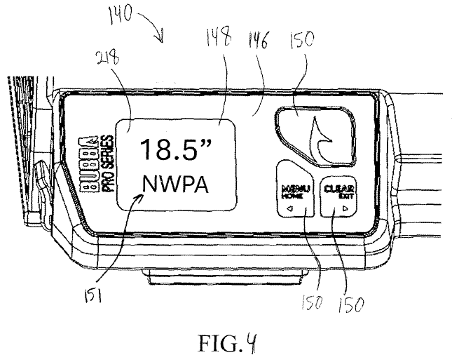

The measurement display 148 is controlled by the controller 200 to present visual information to the user. For example, the display 148 visually conveys the measured length (i.e., length value) of the fish (e.g., 25 cm) to the user. FIG. 4 shows the user interface 140 of the board 100 according to an embodiment. The user interface 140 may have other arrangements of actuators 150 and the display 148 in other embodiments. The display 148 includes a display screen 218 that displays graphical information, such as the length value. In the illustrated example, the display 148 presents a length value of 18.5 inches. The display 148 is a digital display. The display screen 218 may be an LED screen, LCD screen, or the like. The length value and other displayed information is presented using alphanumeric characters/indicia.

In an embodiment, the controller 200 can generate a unique identifier 151 which is displayed on the display 148. The unique identifier 151 may be displayed to authenticate a photo submission showing the fish on the board 100. The photo may be submitted for a tournament. In this variation, the randomly generated identifier 151 is displayed by the measurement display and is visually captured in the picture that is submitted with the length measurement to the tournament. The identifier 151 may also be transmitted by the controller 200, using the wireless port 216, to a user computing device. The tournament officials can then compare the random identifier shown in the picture with the random identifier submitted via the user computing device (e.g., smartphone) to verify the catch. A timestamp can be set by the controller 200 when generating the length measurement and/or transmitting the length data and identifier 151 to the external device. The timestamp is used to verify the time and date of the catch (e.g., the catch occurred while the tournament was ongoing).

Referring back to FIG. 3, the length sensor 212 of the board 100 generates a sensor signal (e.g., length measurement data) that is used by the controller 200 to calculate the length of the fish. For example, the length sensor 212 provides length measurement data to the controller 200. The length measurement data is indicative of the length that the object extends from the bump wall 118 (broadly, reference) when the object is on the upper support surface and is in contact with the bump wall. The length measurement value is based on the length measurement data. The length sensor 212 may be a position sensor, a distance (e.g., range or proximity) sensor, or the like. In an embodiment, the length sensor 212 is operatively connected to the slider 144 and generates the length measurement data based on a position of the slider 144 along the length of the tray 102 (e.g., based on the position of the slider relative to the reference 118). In a first embodiment, the length sensor 212 is a position sensor and measures the position of the slider 144 along the tray 102, which is calibrated to length. In an embodiment, the position sensor includes a combination of a magnet and a switch array. The switch array includes a series of magnetic switches spaced apart in a line. The magnet is mounted to the slider 144 and moves relative to the switch array, which is fixed to the tray 102. Other types of position sensors can be employed on the board 100 in other embodiments. In a second embodiment, the length sensor 212 is a distance sensor and measures a distance from the current position of the slider 144 to a reference component (e.g., the sensor 212 itself, the bump wall 118, etc.). For example, the distance sensor may be mounted in place on the tray 102, and uses time of flight technology to detect the distance of the slider 144 from the distance sensor based on reflection of a beam of electromagnetic radiation off the slider 144.

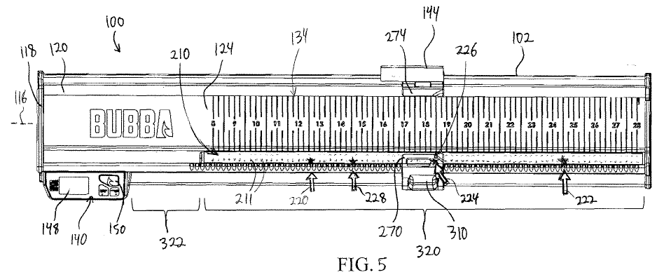

The length display 210 of the board 100 is an elongated display (e.g., display strip) mounted on the tray 102. FIG. 5 is a plan view of the electronic length measuring board 100 with the fish omitted. The length display 210 extends lengthwise parallel to the tray axis 116 and the ruler 134. The length display 210 may be next to the ruler 134. The length display 210 provides a visual indication that quickly and simply presents relevant information to the user measuring the caught fish to enhance the utility of the board 100. For example, the length display can visually indicate one or more length distances relative to the reference 118 (e.g., bump wall). This way, the length display provides a visual marker whose distance from the bump wall is the same as the length distance the marker represents. For example, if the length distance is 6 inches, the visual marker displayed by the length display is 6-inches from the bump wall 118. Example length distances the length display 210 visually indicates can include a lower limit reference length (represents a minimum length of a fish that is considered a keeper according to applicable fishing regulations), an upper limit reference length (represents a maximum length of a fish that is considered a keeper according to applicable fishing regulations), a cull length (represents a shortest recorded length in a set of recorded lengths (e.g., represents the shortest length of fish measured so that the user can compare to the current fish to visually determine if the current fish is longer), and/or a live or actual length (represents the actual length currently being measured).

In the illustrated embodiment, the length display 210 may include a series of discrete light sources 211, such as LEDs, spaced apart along the length of the length display 210. The light sources 211 are communicatively connected to the controller 200 and controlled by the controller 200. The controller 200 controls which of the light sources 211 to illuminate at a given time. The controller 200 may also control characteristics of the light emitted by the selected light source(s) 211, such as wavelength (e.g., color), intensity, variance (e.g., flashing, pulsing, consistent, etc.). Other configurations of the length display can be used without departing from the scope of the present disclosure.

The length display 210 is controlled by the controller 200 to illuminate various positions/locations (i.e., length distances) along the length of the ruler 134 (broadly, object support 102). The locations that are illuminated may be selected based on reference lengths. The length display 210 provides a visual indication of each reference length by emitting light from a respective light source 211 at a location that corresponds to the reference length. Arrows are shown on FIG. 5 to clearly indicate the illuminated reference lengths. The arrows are not actually present on the board 100. FIG. 5 illustrates the electronic measuring board 100 with multiple locations along the length display 210 illuminated.

Some of the designated lengths may define a length range that is acceptable for the caught fish to be kept, rather than released back into the water. For example, the controller 200 controls the length display 210 to emit light from a first location 220 that represents a lower limit of an applicable fish length range, and to emit light from a second location 222 that represents an upper limit of the applicable fish length range. When the measured length of the fish on the tray 102 is between the lower limit and the upper limit, the user may keep the fish (e.g., the fish qualifies as a “keeper”). The fish length range may be based on a regulation or law, such as pertaining to the specific species of fish, location in which the fish was caught, and/or the like. Many areas/regions/states/etc. set minimum length limits and/or maximum length limits for a given fish species to qualify as a legal keeper. These limits can be input/uploaded to the board 100 via an external device 214 communicatively connected to the board 100. By illuminating the lower and upper limits along the board 100, the controller 200 clearly indicates whether the caught fish is within the acceptable range or outside of the range. The user does not have to look up regulations to determine the applicable length range or perform mental math to determine whether the measured length is within the applicable length range.

In an example, a third illuminated reference location 224 represents a live measure indicator. The live measure indicator illuminates an end-of-length pointer 226 of the slider 144. The end-of-length pointer 226 is a mark or indicator on the slider 144 that the user refers to when manually sliding the slider 144. The user visually compares the position of the end-of-length pointer 226 to the end of the fish tail and moves the slider 144 until the two align.

A fourth illuminated reference location 228 represents a cull (or culling) length indicator. The cull length indicator illuminates a location that represents the shortest recorded length of a fish in a set of recorded fish lengths. The set of recorded fish lengths may be associated with a set of fish to submit in a competition. For example, the set may refer to a virtual livewell in a tournament setting, which is a set of fish caught by the user during the tournament which the user plans to submit for scoring. The cull length indicator illuminates the shortest length of fish currently in the virtual livewell. Using the cull length indicia 228, the user can quickly compare the length of the fish currently on the tray 102 to that of the shortest fish in the virtual livewell. If the current fish is longer, the user provides input to add the current fish to the virtual livewell, potentially at the exclusion of the previously recorded shorter fish (if the maximum number of fish in the virtual livewell is already met). If the current fish is shorter, the user releases the current fish without adding it to the virtual livewell. The user may provide input to the board 100 to retain the previously recorded fish in the virtual livewell.

In an embodiment, the controller 200 controls the length display 210 to emit different colors signifying different corresponding reference lengths. For example, the lower/upper length limits 220, 222 is green light, the live measure indicator 224 is red light, and the cull length indicator 228 is yellow light. Other ways of distinguishing between these lengths are within the scope of the present disclosure. The lights may pulse or flash when indicating these lengths/locations.

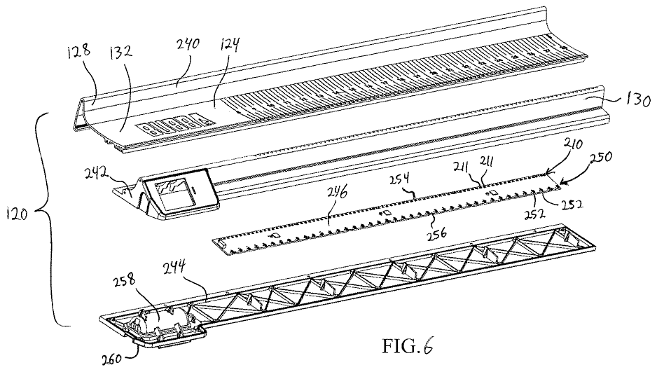

FIG. 6 is an exploded view of the deck 120 of the tray 102 according to an embodiment. In the illustrated embodiment, the deck 120 is an assembly of several parts, including a panel (or shell) 240, an upper housing 242, a lower housing 244, and a circuit board 246. The panel 240, upper housing 242, and lower housing 244 are elongated. Each may extend the full length of the deck 120 between the bump wall 118 and the end wall 122. The panel 240 defines a substantial portion of the upper support surface 124 that receives the fish thereon. For example, the panel 240 defines the first side wall 128 and the base 132. The upper housing 242 defines the second side wall 130 and couples to the panel 240 to complete the upper support surface 124. The panel 240, upper housing 242, and lower housing 244 may each independently have a metal (e.g., aluminum) composition or a plastic composition. These components may be extruded, molded, or the like.

The upper housing 242 connects to the lower housing 244 to define a housing assembly. The housing assembly supports and houses various components of the measuring board 100, such as the controller 200, the length sensor 212 (or a portion thereof), the length display 210, the communication interface(s) 208, the power source 206, and/or the user interface 140. For example, when the housings 242, 244 are mated together, the housings 242, 244 define an interior space. In an embodiment, at least some of the electronic components of the board 100 are mounted on the circuit board 246. In an example, the controller 200 is on the circuit board 246. During assembly, the circuit board 246 is enclosed within the interior space between the upper and lower housings 242, 244.

In an embodiment, the length sensor 212 includes a switch array 250 defined by a plurality of magnetic switches 252 spaced apart along a row. The row may be linear. In an embodiment, the switch array 250 is mounted on the circuit board 246. When the tray 102 is assembled, the switch array 250 may extend a length of the tray 102, parallel to the tray axis 116. The switch array 250 underlies the slider 144. For example, the switch array 250 underlies the slider 144 by being mounted to the circuit board 246 that is protected within the interior region of the deck 120.

In an embodiment, the light sources 211 of the length display 210 are also mounted on the circuit board 246 in a row. The light sources 211 may be spaced apart from the magnetic switches 252 along the surface of the circuit board 246. For example, the length display 210 may be mounted near a first edge 254 of the circuit board 246, and the switch array 250 may be mounted near a second edge 256 of the circuit board 246 that is opposite the first edge 254. In another example, the length display 210 and the switch array 250 are disposed along opposite faces or sides of the circuit board 246. As in, the switch array 250 is disposed along an lower face of the circuit board 246, and the length display 210 is on the upper face.

Although a single circuit board 246 is shown in FIG. 6, the electronic measuring board 100 can include multiple circuit boards that are electrically connected to form a circuit board assembly. As an example, the length display 210 may be disposed on a first circuit board, and the switch array 250 on a second circuit board.

The housing assembly may include a seal or gasket at an interface between the upper and lower housings 242, 244, to restrict moisture and other contaminants from entering the interior space. The gasket extends around a perimeter of the interior to form a fluid-tight seal.

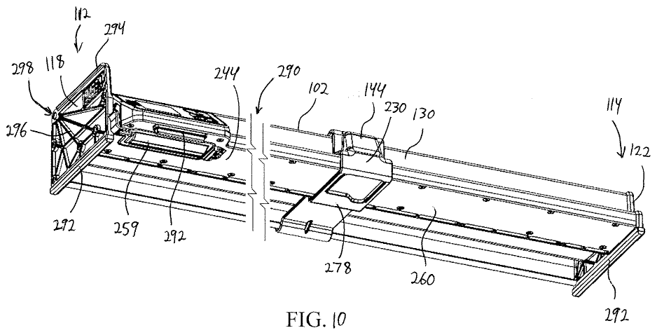

The lower housing 244 may include a compartment 258 for removably holding one or more batteries (e.g., the power source 206) therein. The compartment 258 is open along a bottom side 260 of the lower housing 244, for inserting and removing the batteries relative to the compartment 258. The tray 102 may include a removable cover 259 (shown in FIG. 10) that closes the compartment 258 and secures the battery or batteries therein. The cover 259 and/or tray 102 can include a gasket at the interface between the cover 259 and the lower housing 244 for preventing moisture and other contaminants from entering the compartment 258.

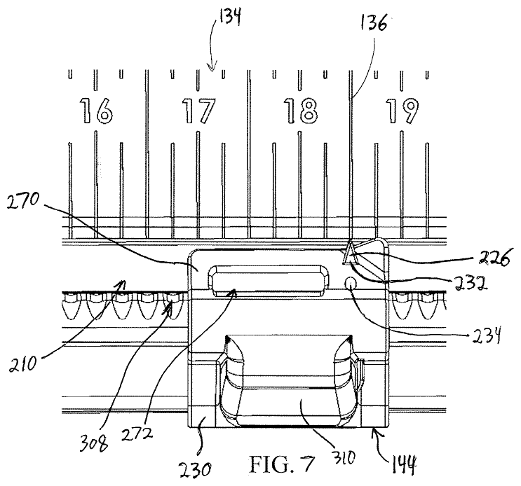

Referring to FIG. 7, the slider 144 has a slider body 230. The end-of-length indicator or pointer 226 is coupled to the slider body 230 or is an integral feature of the slider body 230. The user moves the slider 144 to align the end-of-length indicator 226 with the distal end of the object. The end-of-length pointer 226 may be an arrow, a line transverse to the length of the ruler 134, an opening (e.g., notch, slot, etc.), or the like. In the illustrated embodiment, the end-of-length pointer 226 includes an arrow or triangle 232 that “points” in a direction perpendicular to the length of the ruler 134 (e.g., parallel to the ruler markings 136). In an embodiment, the end-of-length pointer 226 includes a see-through insert 234 that is discrete from the slider body 230 and affixed to the slider body 230. The see-through insert 234 may be transparent or at least translucent. For example, the insert 234 may be composed of a relatively clear plastic or glass material. The insert 234 may be illuminated by a light source 211 of the length display 210 that underlies the insert 234.

In operation, the controller 200 determines which light source 211 is directly below (e.g., is closest to) the end-of-length pointer 226. This determination may be based on a sensor signal generated by the length sensor 212 and a known relationship between the length sensor 212 (and/or length data) and the length display 210. As shown in FIG. 6, the light sources 211 of the length display 210 are spaced apart in a row parallel to the magnetic switches 252 of the switch array 250. The locations of the light sources 211 and the magnetic switches 252 on the circuit board 246 are fixed. Based on the fixed locations and parallel rows, the controller 200 knows which specific light source 211 is most closely aligned with any given magnetic switch 252. The magnetic switches 252 in the switch array 250 detect the position of the slider 144 by interacting with a magnet mounted in the slider 144. For example, the controller 200 determines the position of the slider 144 along the tray 102 based on signals received from the switch array 250, where the signals are affected by the location of the slider 144 carrying the magnet. The controller 200 electromagnetically determines the a first magnetic switch 252 that is closest to the end-of-length pointer 226, and then determines the light source 211 of the length display 210 that most closely aligns with the first magnetic switch 252. Upon determining the relevant light source 211 closest to the end-of-length pointer 226, the controller 200 activates that light source 211. Light emitted by that light source 211 (e.g., LED) penetrates and illuminates the see-through insert 234. The result is a glowing end-of-length pointer 226, which draws attention to the pointer 226 and makes it visually distinctive.

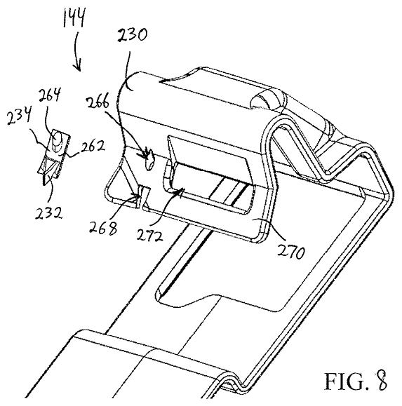

Referring to FIG. 8, the slider body 230 has multiple bends along its length. The slider body 230 may be formed via molding. In an example, the slider body 230 has a plastic composition. Other compositions and shapes of the slider 144 are contemplated without departing from the scope of the present disclosure, such as a sheet metal slider body 230 that is bent and formed into shape.

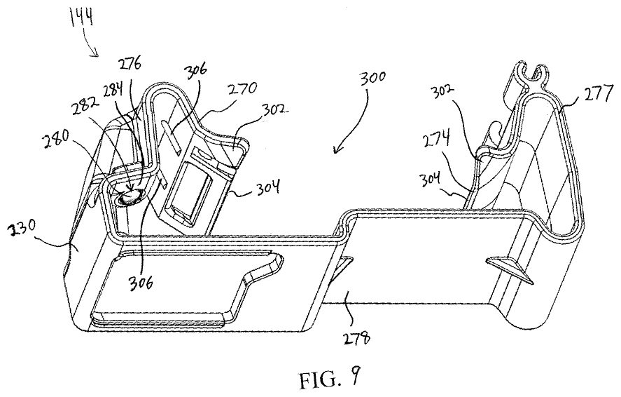

The slider 144 includes the slider body 230 and the see-through insert 234. The slider 144 according to an embodiment also includes a magnet 280 (shown in FIG. 9) of the length sensor 212. The magnet 280 is carried by and moveable with the slider 144. As described above, the see-through insert 234 is affixed to the slider body 230 and positioned over the length display 210. The insert 234 is illuminated by the light source 211 that is determined to be the live measure indicator. In an embodiment, the insert 234 has a base 262, a first indicator shape (e.g., circle/cylinder) 264, and the arrow 232 (broadly, a second indicator shape). Both the first indicator shape 264 and the arrow 232 project from the base 262. The first indicator shape 264 in the illustrated embodiment is a cylinder, but other shapes can be used in other embodiments. The insert 234 may function as a light guide, transmitting light internally between the arrow 232 and the cylinder 264, so that both indicators are illuminated by a common light source 211 (e.g., LED) of the length display 210. The slider body 230 defines a hole 266 and a notch 268 through a tail guide 270 of the slider 144. The cylinder 264 is received into the hole 266 and the arrow 232 into the notch 268 when the insert 234 is mounted to the tail guide 270. In another embodiment, the see-through insert 234 only has one indicator, rather than two, such as only the arrow 232.

The slider 144 may include or define an elongate viewing slot (e.g., a window) 272 through the tail guide 270. The viewing slot 272 allows the user to view a portion of the length display 210 that is underneath the tail guide 270. For example, light emitted from the length display 210 near the end of the fish may be shown through the viewing slot 272. Such light can include light indicators such as the length lower limit indicator, the length upper limit indicator, and the cull length indicator, as shown in FIG. 5. Without the viewing slot 272, one or more of the light indicators may be obstructed from view by the opaque tail guide 270 of the slider body 230.

Referring to FIGS. 9-11, the slider 144 wraps around the bottom of the tray 102. The slider 144 also wraps around the side walls 128, 130. For example, the slider 144 has a one-piece body 230 and connects to the tray 102 by engaging the side walls 128, 130 and the bottom of the tray 102. The tail guide 270 is a first tail guide and contacts an inner surface 288 of the second side wall 130. The slider body 230 has a second tail guide 274 that contacts an inner surface 289 of the first side wall 128. The inner surfaces 289, 288 of the side walls 128, 130 define sides of the trough 126. The physical contact with the inner surfaces 289, 288 operates to couple the slider 144 to the tray 102 and retain the slider 144 on the tray 102 during ordinary use of the measuring board 100.

In an embodiment, the slider body 230 includes a first ear 276 (broadly, connector), a second ear 277 (broadly, connector), and a beam 278. The beam 278 is located between the ears 276, 277 and connects the ears. Each ear 276, 277 connects to one of the side walls to secure the slider 144 to the tray 102. The first ear 276 is referred to herein as a pusher ear 276 because it is located along the same side wall 130 as the user interface 140, and is manually handled by the user to move the slider 144 along the tray 102. The pusher ear 276 includes the first tail guide 270. The second ear 277 includes the second tail guide 274. The first and second tail guides 270, 274 are spaced apart from one another across the ruler 134 and define a tail receiving space 300 therebetween.

In the embodiment in which the length sensor 212 includes the magnet 280, the magnet 280 is affixed to the slider body 230 and moves with the slider 144 relative to the tray 102. In FIG. 9, the magnet 280 is housed within a recess (e.g., pocket, depression, crater, etc.) 282 along the pusher ear 276. The recess 282 is defined along a downward-facing surface 284 of the ear 276 that overlies a portion of the tray 102. The magnet 280 may be exposed (e.g., uncovered) within the recess 282. The magnet 280 may be inline with the end-of-length indicator 226 of the slider 144. Therefore, when the end-of-length indicator 226 aligns with the end of the fish, so too does the magnet 280. As described above, the magnet 280 electromagnetically interacts with the magnetic switches 252 of the switch array 250 (shown in FIG. 6). Sensor signals generated by the switch array 250 are conveyed to the controller 200 to determine the length of the fish held on the tray 102.

FIG. 10 includes break lines 290 to indicate that the measuring board 100 can have various lengths. The length may be selected based on the size of the objects that the user intends to measure. As shown in FIG. 10, the beam 278 of the slider body 230 extends under the tray 102 and contacts a bottom side 260 of the lower housing 244. The measuring board 100 includes feet 292 that project from the bottom of the tray 102 for supporting the measuring board 100 on a surface, such as a wet boat deck. When the feet 292 rest on a surface, the slider 144 is elevated above the surface, so the slider 144 can move along the deck 120 without obstruction or interference from the surrounding environment. In the illustrated embodiment, feet 292 are located at the ends 112, 114 of the board 100, providing a stable base. The bump wall 118 includes one foot 292, and the distal end wall 122 has another foot 292. In the illustrated embodiment, the lower housing 244 has at least one foot 292, located near the battery cover 259. The foot 292 near the battery cover 259 is beyond the path of movement of the slider 144, so does not obstruct the slider 144. The feet 292 may have non-slip surfaces to inhibit the measuring board 100 from sliding on wet surfaces. The feet 292 may also dampen sound when placing the measuring board 100 on a hard surface. The feet 292 may be formed out of an elastomeric material (e.g., rubber), and can be over-molded onto the body of the tray 102 (e.g., underside thereof).

In an embodiment, the bump wall 118 includes pad or bumper 294 at the upper end thereof (e.g., forming the upper end of the bump wall). The pad 294 can be formed out of an elastomeric material (e.g., rubber), and can be over-molded onto the body of the bump wall 118. The pad 294 can provide acoustic damping and/or grip, such was when placing the measuring board 100 against the desk or gunnel of a boat (e.g., kayak). The bump wall 118 can include one or more ribs 296 or other reinforcement structures for strengthening the bump wall 118, which structurally supports the board 100.

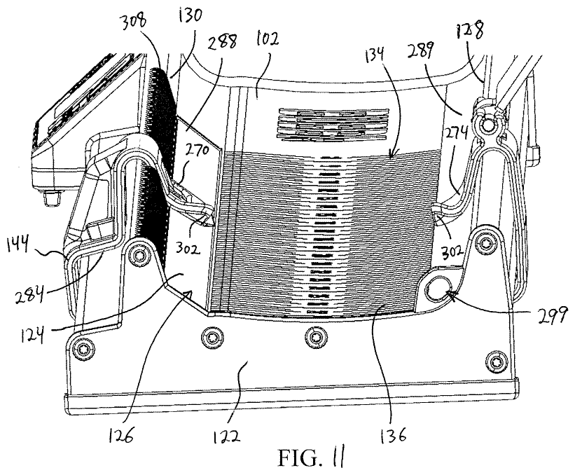

Optionally, the measuring board 100 may include one or more tether attachment points (e.g., openings) for connecting to a tether or cord, such as for portability. In the illustrated embodiment, the measuring board 100 includes two tether attachment points 298, 299, one at each end of the tray 102. The bump wall 118 has a first tether attachment point 298. The distal end wall 122 has the second tether attachment point 299, as shown in FIG. 11. In the illustrated embodiment shown in FIG. 10, some of the ribs 296 of the bump wall 118 extend from the tether attachment point (e.g., opening) 298 to attachment locations (e.g., fastener openings), which are locations of fasteners that couple the bump wall 118 to the deck 120. The distal end wall 122 can also include one or more structural ribs like the bump wall 118.

With reference to FIGS. 2, 9 and 11, the slider 144 includes a pincher (e.g., tail pincher), pinch, or tool configured to engage and pinch/squeeze the object (e.g., tail of the fish). This aids the operator in placing the fish on the tray 102 extended to its full length (e.g., a fish is typically longer when the tail is squeezed). The tail pincher aids in consistent measurement of a given fish, and can be particularly useful for larger fish species, such as redfish. In the illustrated embodiment, the pincher is formed by the tail guides 270, 274, or wings, of the slider 144. When assembled, the first and second tail guides 270, 274 are arranged along opposite sides of the upper support surface 124 (e.g., the trough 126). The tail guides 270, 274 are spaced apart and across from each other, and define a space (e.g., tail receiving space) 300 therebetween, as shown in FIG. 9. When the slider 144 aligns with a portion of the ruler 134, the ruler indicia 136 are located in the tail receiving space 300 between the tail guides 270, 274. In use, the tail of the fish is placed to lie flat on the upper support surface 124 between the tail guides 270, 274. The tail guides engage opposite sides or edges (e.g., top and bottom) of the tail and squeeze the tail. In an embodiment, each tail guide 270, 274 includes a respective upturned lip 302. The upturned lip 302 curls upward, away from the underlying inner surface 289, 288 of the corresponding side wall 128, 130. The lips 302 also curl out of the plane of the surrounding areas of the tail guides 270, 274. The upturned lip 302 may be a ramp. For example, the lips 302 project from the surrounding area of the tail guides 270, 274 generally towards a mid-line of the upper support surface 124 and generally towards each other. The lip 302 may be located at a distal edge 304 of the tail guide 270, 274, such as at a corner thereof. When the slider 144 is positioned at the tail end of the fish, the upturned lips 302 lift the edges of the tail off the tray 102 and push the edges of the tail toward one another, thereby squeezing the tail between the tail pincher. Other configurations of the pincher can be used without departing from the scope of the present disclosure.

In an embodiment, the slider 144 is adjustable to be positioned at any of a series of predefined stop positions at set increments along the length of the tray 102. The slider 144 includes a first set of one or more locators which engage and interact with a second set of locators spaced apart along the length of the tray 102 to locate and position the slider 144 along the tray 102 at discrete increments. In an example, the increments are ¼-inch increments. The increments of the locators may coincide with increments of the ruler markings 136. This creates a natural alignment or correspondence of the end-of-length indicia 226 of the slider 144 and an associated one of the ruler markings 136 at each stop position of the slider 144.

In the illustrated embodiment, the first set of locators on the slider 144 are protrusions, and the second set of locators on the tray 102 are recesses/channels that receive the protrusions. For example, the first set of locators are one or more ribs (broadly, projections) 306 on the slider 144. As shown in FIG. 9, the first tail guide 270 has ribs 306 along an underside thereof. The ribs 306 are received by corresponding grooves (broadly, keepers or receivers) 308 spaced from each other along the length of the tray 102. (e.g., along the ruler). The grooves 308, shown for example in FIGS. 7, 11 and 12, are located along the side wall 130 that is engaged by the first tail guide 270. In an embodiment, the magnetic switches 252 of the switch array 250 also include the same pitch (or spacing) between switches 252 as the grooves 308. For example, the switches 252 may have quarter inch increments. In another embodiment, the second set of locators on the tray 102 are protrusions, and the first set of locators on the slider 144 are recesses/channels that receive the protrusions. The associated description applies to either arrangement.

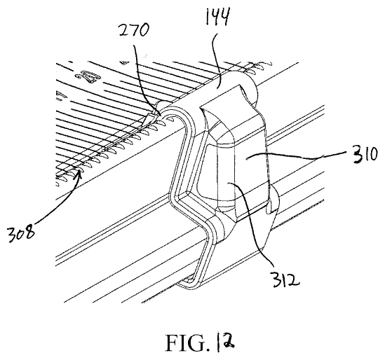

The mating of the ribs 306 with a grooves 308 may produce an audible sound (e.g., “click”) indicating the slider 144 is aligned with one of the ruler markings 136. The user applies a sufficient amount of force to force the ribs 306 out of the grooves 308 to move the slider 144 along the tray. Referring to FIG. 12, the slider include an actuator 310 that is manually manipulated or engaged by the user to move the slider 144 along the tray 102. In the illustrated embodiment, the actuator 310 comprises a tab (e.g., pusher tab). As the slider 144 is moved left/right along the tray 102 by the user pushing left/right on the actuator 310, the user hears the “clicking” of the protrusions engaging the keepers (e.g., ribs 306 being received within the grooves 308).

In another mode of moving the slider 144, the user can manipulate the slider 144 to disengage the protrusions from the set of keepers to slide the slider 144 without the tactile or audible “clicking”. The slider 144 can be resiliently deformable (e.g., resilient plastic body 230) to permit the user to move the ribs 306 out of engagement with the grooves 308. For example, the user can force the actuator 310 inward towards a midline of the upper support surface 124 so that the first tail guide 270 separates, at least partially, from the inner surface 288 of the side wall 130 and the ribs 306 exit the grooves 308. This allows the user to quickly move the slider 144 along the length of the tray 102, as well as eliminating the audible clicks that would otherwise occur at each increment.

The actuator 310 is a generally laterally outward facing push surface against which the user pushes to move the protrusions out of engagement with the keepers (e.g., the ribs 306 out of engagement with the grooves 308). The user maintains the inward force against the pusher tab 310 as the user slides the slider 144. The actuator 310 may include a grip 312 or rubber pad having a non-slip surface for easier control. The grip 312 may be formed out of an elastomeric material, and can be over-molded onto the slider body 230. In the illustrated embodiment, the actuator 310 has an angled outer surface that faces laterally outward and slightly upward. The actuator 310 is sized and shaped to be gripped by the user's fingers, such as pinched between the index finder and thumb of the user's hand.

Other configurations can be used without departing from the scope of the present disclosure. For example, In an alternative embodiment, the slider 144 is freely movable and continuously adjustable along the tray 102. The slider 144 and tray 102 may not include the locators described above. For example, the slider 144 may stop and stay at different designated positions along the length of the tray 102 due to friction. Optionally, the slider 144 may be biased to apply compressive forces against the tray 102, providing friction that resists movement of the slider 144 relative to the tray 102.

The following description of controller 200 operations of the electronic measuring board 100 refers to FIGS. 3 and 5. Initially, the user utilizes the user interface 140 to either turn the board 100 on and/or verify that the board 100 is already on. The user manually places the fish (or other object to be measured) onto the upper support surface 124 of the deck 120, with a mouth of the fish (e.g., end of the object) in contact with the bump wall 118. The user may have to manipulate the tail to ensure that the tail is in the space between the two tail guides 270, 274 of the slider 144 (e.g., is aligned with the ruler 134). With the fish resting in place on the upper support surface 124, the user grips the actuator 310 of the slider 144 and moves the slider 144 along a length of the tray 102 until the end-of-length indicator 226 of the slider 144 aligns with (e.g., points to) the end of the fish tail, as shown in FIG. 2. At this stage, the user may press the measure actuator (e.g., button) 150 of the user interface 140 to command the controller 200 to generate a length measurement of the fish. Alternatively, the controller 200 may automatically generate the length measurement based on the position of the slider 144, without waiting for a user input as a trigger event.

The controller 200 uses the length sensor 212 to generate the length measurement. As described above, the length sensor 212 according to an embodiment includes the magnet 280 carried by the slider 144 and the switch array 250 (broadly, sensor array), which extends along a length of the tray 102 and is fixed in place on the tray 102. The switch array 250 detects the presence of the magnet 280 on the slider 144 and generates a sensor signal (e.g., length measurement signal) which is conveyed to the controller 200. The sensor signal indicates the position of the magnet 280 along the length of the switch array 250. For example, the magnetic switches 252 in the array 250 may be actuated or otherwise electromagnetically affected by proximity of the magnet 280. Each magnetic switch 252 may be actuated when the magnet 280 is aligned with (e.g., closest to) that magnetic switch 252, and may not be actuated when the magnet 280 is farther away. The controller 200 can determine the position of the magnet 280 relative to the switch array 250 based on characteristics of the sensor signal(s), such as which switch 252 or switches 252 are actuated by the magnet 280. The positioning of each magnetic switch 252 on the circuit board 246 may be known by the controller 200, so the controller 200 knows or determines the distance of each switch 252 from the bump wall 118 based on the installed position of the circuit board 246 relative to the bump wall 118. The sensor signals may be generated by magnetic sensors 252 in the array 250. The controller 200 uses the received sensor signal(s) to determine the distance of the end-of-length indicator 226 of the slider 144 from the bump wall 118, which represents the length of the fish. The controller 200 controls the measurement display 148 to display a length value that represents the length measurement. As described above, the controller 200 can determine the length of the fish without reference to the ruler 134. The ruler 134 is provided to assist the user with positioning the slider 144 at the end of the fish tail. Optionally, the ruler 134 may be omitted.

After determining the length of the fish, the controller 200 may automatically, or on-demand in response to receiving a user input, generate a measurement message that includes the length value or an indication thereof and control the wireless port 216 to transmit the measurement message to at least one external device 214. The user input that triggers the sending of the message may be the user pressing a transmit button on the user interface 140, or using an external device, such as a smartphone, to request the measurement message.

During the measurement process, the controller 200 controls the length display 210 to provide one or more illuminated indicators as described above, which presents helpful information to the user. Similar to the magnetic switches 252, the lights 211 (e.g., LEDs) of the length display 210 are spaced apart to extend along a length of the tray 102 and are fixed in place on the tray 102. The controller 200 knows the position of each light source 211 on the circuit board 246, so the controller 200 knows or determines the distance of each light source 211 from the bump wall 118. Put another way, each light source 211 is associated with a predetermined length. Once the controller 200 determines the relevant reference lengths to display, the controller 200 simply matches the reference length to the corresponding light source 211 associated with that length, and activates that light source 211 to emit light. For example, upon determining that the length lower limit for keeping fish is seven inches, the controller 200 activates the specific light source 211 along the length of the length display 210 that is positioned at the seven inch location (seven inches from the bump wall 118). The controller 200 determines the relevant reference lengths by accessing the data from the memory 204, receiving the data from a remote source (e.g., an external device 214), the user inputting the data via the user interface 140, or the like. The length display 210 is calibrated with the ruler 134, so that the light indicators of the length display 210 align with ruler markings 136 of the ruler 134.

In an embodiment, the controller 200 changes modes or settings of the measuring board 100 based on a position of the slider 144. For example, the slider 144 can be used by the user to change between a first mode and a second mode. The first mode is a measurement or operational mode (length measuring mode) in which the measuring board 100 operates to measure the length of the fish. The second mode is a setting or menu mode that enables the user to view and alter settings of the control system and/or other attributes of the system. One example setting is whether or not the controller 200 displays the unique identifier 151 (shown in FIG. 4) on the measurement display 148. Another setting controls which reference lengths are indicated by the length display 210.

In this embodiment, the location of the slider 144 along the tray 102 sets which mode the control system is in. When the slider 144 is in a first section 320 along the tray 102, the control system is in the measurement mode. The measurement display 148 displays the measured length, and the length display 210 indicates the measured length (and other reference lengths if desired). The first section 320 generally aligns with the ruler 134 and the length display 210. The measuring of the fish occurs when the slider 144 is located within the first section 320. For example, when the slider 144 is activating any magnetic switch or switches 252 of the length sensor 212, the slider 144 is in the first section 320.

The second section 322 is between the first section 320 and the bump wall 118. For example, the second section 322 is located between the user interface 140 and a proximal end of the ruler 134. When the slider 144 is in the second section 322 along the tray 102, the control system is in the settings mode. While in the settings mode, the measurement display 148 displays settings and other attributes of the system. The second section 322 may be characterized by the absence of the switch array 250. When the slider 144 is not activating any switch 252 of the switch array 250 that corresponds to a measured length, the slider 144 is in the second section 322.

In another embodiment, the slider 144 is not capable of switching to a settings mode. The slider 144 is restricted to the first section 320 shown in FIG. 5, and one or more input actuators 150 (e.g., buttons) on the user interface 140 are pressed to access and modify settings.

In an embodiment, the controller 200 communicates via the wireless port 216 with a mobile computing device that represents the external device 214. The mobile computing device, such as a smartphone, may run a program or application that utilizes the length values received from the measuring board 200. The computing device may integrate the length values with additional information, such as geographic location data, weight data of the fish (received from a fish scale), and/or the like. The computing device may forward the length data and other pertinent information to a remote device, such as a computer/server running a fishing tournament. Wirelessly transmitting the measured length from the electronic measuring board 100 to the remote device eliminates the need for the user to manually enter a length for the fish. The user can log a catch by weight and length. The app can be used in tournament purposes (e.g., virtual fishing tournaments), in which the electronic measuring board 100 sends the length of the fish to the app to upload and record for the fishing tournament.

Although described in connection with an example computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of well-known computing systems, computing circuitry, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers, which include computing circuitry, may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the disclosure defined in the appended claims. For example, where specific dimensions are given, it will be understood that they are exemplary only and other dimensions are possible. As various changes could be made in the above constructions, products, and methods without departing from the scope of the disclosure, it is intended that all matter contained in the above description and shown in the accompanying drawings shall be interpreted as illustrative and not in a limiting sense.

What is claimed is:

1. An electronic fish measuring device for measuring the length of a fish, the electronic fish measuring device comprising:
a fish support including an upper support surface configured to receive the fish thereon, the fish support including a reference configured to contact the fish when the fish is on the upper support surface;
a length sensor configured to generate length measurement data indicative of a length that the fish extends from the reference when the fish is on the upper support surface and is in contact with the reference;
a measurement display supported by the fish support; and
a controller operatively connected to the length sensor and the measurement display, the controller configured to control the measurement display to display a length measurement value corresponding to the length of the fish for visual observation by a user, the length measurement value being based on the length measurement data.

2. The electronic fish measuring device of claim 1, further comprising a length display configured to visually indicate one or more length distances relative to the reference.

3. The electronic fish measuring device of claim 2, wherein the one or more length distances the length display is configured to visually indicate includes a lower limit reference length and an upper limit reference length.

4. The electronic fish measuring device of claim 2, wherein the one or more length distances the length display is configured to visually indicate includes a cull length that represents a shortest recorded length in a set of recorded lengths.

5. The electronic fish measuring device of claim 2, further comprising a slider that is coupled to the fish support and manually repositionable along the fish support, the slider including an end-of-length indicator configured to align with a distal end of the fish that is on the fish support when the slider is repositioned along the fish support, wherein the controller is configured to activate a portion of the length display that aligns with the end-of-length indicator of the slider.

6. The electronic fish measuring device of claim 1, wherein the length sensor includes a magnet that is movable along the fish support and a switch array, the switch array comprising a row of magnetic switches spaced apart along the fish support and configured to be actuated by the magnet based on proximity of the magnet to the magnetic switches.

7. The electronic fish measuring device of claim 6, further comprising a slider moveable relative to the reference, wherein the magnet is carried by and moveable with the slider.

8. The electronic fish measuring device of claim 6, wherein the slider includes an end-of-length indicator configured to be aligned by the user with the distal end of the fish when the slider is moved relative to the reference.

9. The electronic fish measuring device of claim 1, further comprising a slider that is moveable along the fish support to align with a distal end of the fish when the fish is on the fish support, the length sensor being operatively connected to the slider and configured to generate the length measurement data based on a position of the slider relative to the reference.

10. The electronic fish measuring device of claim 9, wherein the fish support includes side walls that define sides of the upper support surface, wherein the slider includes two ears, each ear connected to one of the side walls to secure the slider to the fish support.

11. The electronic fish measuring device of claim 9, wherein that the slider includes an actuator configured to be manually manipulated to move the slider along the fish support.

12. The electronic fish measuring device of claim 9, wherein the slider includes a pincher configured to engage and pinch the distal end of the fish.

13. The electronic fish measuring device of claim 12, wherein the pincher includes a pair of opposed winged guides configured to pinch the distal end of the fish therebetween.

14. The electronic fish measuring device of claim 9, wherein the fish support includes a set of first locators spaced apart along the fish support, the slider including a second locator that is complementary to the first locators and is configured to engage the first locators to secure the slider at different incremental positions along the fish support.

15. The electronic fish measuring device of claim 9, wherein the controller is configured to switch from a first mode of operation to a second mode of operation in response to a second length measurement data generated by the length sensor indicating that the slider has moved from a first section of the fish support to a second section of the fish support.

16. The electronic fish measuring device of claim 15, wherein the first mode of operation is a length measuring mode and the second mode of operation is a settings mode.

17. The electronic fish measuring device of claim 1, further comprising a wireless port configured to establish a wireless communication path with an external electronic device, the wireless port configured to communicate a measurement message indicative of the length measurement value to the external electronic device.

18. The electronic fish measuring device of claim 1, wherein the measurement display is a digital display and displays the length measurement value as a number.

19. The electronic fish measuring device of claim 1, wherein the fish support includes a ruler extending along the upper support surface.

20. An electronic fish measuring device for measuring the length of a fish, the electronic fish measuring device comprising:
a fish support including an upper support surface configured to receive the fish thereon, the fish support including a reference configured to contact the fish when the fish is on the upper support surface;
a length sensor configured to generate length measurement data indicative of a length that the fish extends from the reference when the fish is one the upper support surface and is in contact with the reference;
a wireless port configured to communicate with an external electronic device; and
a controller operatively connected to the length sensor and the wireless port, the controller configured to cause the wireless port to send a measurement message to the external electronic device as a function of the length measurement data.
